(19) United States
(12) Patent Application Publication
(10) Pub. No.: US 2019/0271774 A1
(43) Pub. Date: Sep. 5, 2019

(54) METHOD AND APPARATUS FOR MOTION DETECTION SYSTEMS

(71) Applicant: QUALCOMM Incorporated, San Diego, CA (US)

(72) Inventors: Xiaoxin ZHANG, Sunnyvale, CA (US); Youngsin LEE, Seoul (KR); Ning ZHANG, Saratoga, CA (US)

(21) Appl. No.: 15/909,830

(22) Filed: Mar. 1, 2018

(51) Int. Cl. G01S 13/56; H04L 25/02

(52) U.S. Cl. CPC G01S 13/56; H04W 4/029; H04L 25/0212

(57) ABSTRACT

Method, apparatus and systems for detecting motion of an object or person have been disclosed. The method and the accompanying apparatus for motion detection include determining a plurality of channel impulse response (CIR) power profiles over a plurality of time sampling taps of one or more received signals, time aligning the plurality of the CIR power profiles based on time sampling taps of one or more occurrences of peak CIR power levels being above a threshold in each of the plurality of the CIR power profiles for generating a reference CIR power profile, and detecting motion based on a comparison of the reference CIR power profile to a captured signal CIR power profile. The detecting motion may be based on a coarse motion detection process, and followed by a fine motion detection process if a correlation degree threshold is below a level in the coarse motion detection process.

### TECHNICAL FIELD

This disclosure relates generally to wireless networks, and specifically to detecting the presence or motion of an object.

### DESCRIPTION OF THE RELATED TECHNOLOGY

A wireless local area network (WLAN) may be formed by one or more access points (APs) that provide a shared wireless medium for use by a number of client devices. Each AP, which may correspond to a Basic Service Set (BSS), periodically broadcasts beacon frames to enable compatible client devices within wireless range of the AP to establish and/or maintain a communication link with the WLAN. WLANs that operate in accordance with the IEEE 802.11 family of standards are commonly referred to as Wi-Fi networks.

The Internet of Things (IoT), which may refer to a communication system in which a wide variety of objects and devices wirelessly communicate with each other, is becoming increasingly popular in fields as diverse as environmental monitoring, building and home automation, energy management, medical and healthcare systems, and entertainment systems. IoT devices, which may include objects such as sensors, home appliances, smart televisions, light switches, thermostats, and smart meters, typically communicate with other wireless devices using communication protocols such as Bluetooth and Wi-Fi.

In at least one application of IoT, detecting an object or motion of an object in an environment where Wi-Fi network exits is highly desirable. The information resulting from detecting the motion of an object has many useful applications. For example, detecting motion of an object assists in identifying an unauthorized entry in a space. Therefore, it is important to detect the motion of an object in a reliable and accurate manner.

### SUMMARY

Method, apparatus and systems for detecting motion of an object or person have been disclosed. The method and the accompanying apparatus for motion detection include determining a plurality of channel impulse response (CIR) power profiles over a plurality of time sampling taps of one or more received signals, time aligning the plurality of the CIR power profiles based on time sampling taps of one or more occurrences of peak CIR power levels being above a threshold in each of the plurality of the CIR power profiles for generating a reference CIR power profile, and detecting motion based on a comparison of the reference CIR power profile to a captured signal CIR power profile. The time aligning the plurality of the CIR power profiles may be based on a time sampling tap of the first peak CIR power level being above the threshold in each of the plurality of the CIR power profiles. The threshold used to time align the plurality of the CIR power profiles may be based on a level of a time sampling tap of the strongest peak in each of the plurality of the CIR power profiles. The time aligning the plurality of the CIR power profiles may be based on presence of the strongest cross correlation level among two or more of the plurality of the CIR power profiles. The comparison of the reference CIR power profile to the captured signal CIR power profile may include determining a correlation level between the reference CIR power profile and the captured signal CIR power profile, wherein when the correlation level is less than a correlation degree threshold presence of motion is declared. The correlation degree threshold may be based on a cross correlation level among two or more of the plurality of the CIR power profiles. The correlation degree threshold may be based on a cross correlation level between the reference CIR power profile and one or more of the plurality of the CIR power profiles. The correlation degree threshold may be based on a received signal strength of the one or more received signals. The correlation degree threshold may be based on a multipath amount of the one or more received signals. The detecting motion based on a comparison of the reference CIR power profile to the captured signal CIR power profile may be based on a coarse motion detection process, and followed by a fine motion detection process if the correlation degree threshold is below a level in the coarse motion detection process.

### BRIEF DESCRIPTION OF THE DRAWINGS

FIG. 1 shows a block diagram of a wireless system.

FIG. 2 shows a block diagram of an access point.

FIG. 3 shows a block diagram of a wireless device.

FIG. 4A shows a transmission of a multipath wireless signal in a room without motion.

FIG. 4B shows a transmission of a multipath wireless signal in a room with motion.

FIG. 4C shows another transmission of a multipath wireless signal in a room with motion.

FIG. 5A shows an example channel impulse response of the multipath wireless signal of FIG. 4A.

FIG. 5B shows an example channel impulse response of the multipath wireless signal of FIG. 4B.

FIG. 6 shows an example ranging operation.

FIG. 7 shows another example ranging operation.

FIG. 8A shows an example fine timing measurement (FTM) request frame.

FIG. 8B shows an example FTM action frame.

FIG. 9 shows an example FTM parameters field.

FIGS. 10A, 10B and 11 show respectively in accordance with two different aligning algorithms exemplary CIR power profiles before and after aligning over the selected taps.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network. Such systems or network are capable of transmitting and receiving RF signals. The transmission and reception of the signals may be according to any of the IEEE 802.16 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Given the increasing number of IoT devices deployed in home and business networks, it is desirable to detect motion of objects or people in such networks. For example, one or more IoT devices can be turned on or off when a person enters or leaves a room or a space. However, because using motion sensors in such system and networks can increase costs and complexity, it would be desirable to detect motion without using motion sensors.

Implementations of the subject matter described in this disclosure may be used to detect motion using wireless RF signals rather than using an optical, ultrasonic, microwave or infrared motion sensing detectors. For some implementations, a first device may receive a wireless RF signal from a second device, and estimate channel conditions based on the wireless signal. The first device may detect motion of an object or a person based at least in part on the estimated channel conditions. In some aspects, the first device may detect motion based on one or more comparisons between the estimated channel conditions and a number of reference channel conditions. The number of reference channel conditions can be determined continuously, periodically, randomly, or at one or more specified times.

The wireless signal includes multipath signals associated with multiple arrival paths, and the detection of motion can be based on at least one characteristic of the multipath signals. In some implementations, the first device can detect motion by determining an amount of multipath based on the estimated channel conditions, comparing the determined amount of multipath with a reference amount, and indicating a presence of motion based on the determined amount of multipath differing from the reference amount by more than a value. The difference between the determined multipath amount and the reference multipath amount indicates presence or absence of motion in the space/room. In some aspects, the first device can determine the amount of multipath by determining a channel impulse response (CIR) of the wireless signal, and determining a root mean square (RMS) value of a duration of the CIR. In other aspects, the first device can determine the amount of multipath by determining a CIR of the wireless signal, identifying a first tap and a last tap of the determined CIR, and determining a duration between the first tap and the last tap.

In other implementations, the first device can detect motion by identifying a first arrival path of the wireless signal, determining a power level associated with the first arrival path, comparing the determined power level with a reference power level, and indicating a presence of motion based on the determined power level differing from the reference power level by more than a value.

As used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. In addition, the term “legacy device” as used herein may refer to a device that operates according to the IEEE 802.11a/g standards, and the term “HE device” as used herein may refer to a device that operates according to the IEEE 802.11ax or 802.11az standards.

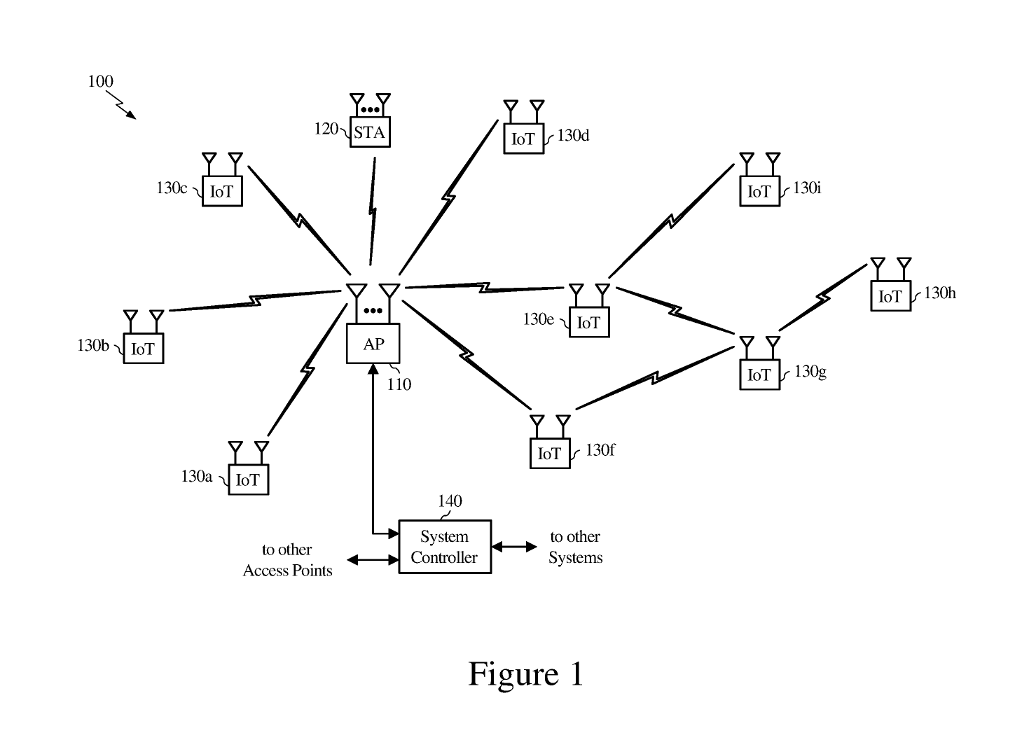

FIG. 1 shows a block diagram of an example wireless system 100. The wireless system 100 is shown to include a wireless access point (AP) 110, a wireless station (STA) 120, a plurality of Internet of Things (IoT) devices 130a-130h, and a system controller 140. For simplicity, only one AP 110 and only one STA 120 are shown in FIG. 1. The AP 110 may form a wireless local network (WLAN) that allows the AP 110, the STA 120, and the IoT devices 130a-130i to communicate with each other over a wireless medium. The wireless medium, which may be divided into a number of channels, may facilitate wireless communications via Wi-Fi signals (such as according to the IEEE 802.11 standards), via Bluetooth signals (such as according to the IEEE 802.15 standards), and other suitable wireless communication protocols. In some aspects, the STA 120 and the IoT devices 130a-130i can communicate with each other using peer-to-peer communications (such as without the presence or involvement of the AP 110).

In some implementations, the wireless system 100 may correspond to a multiple-input multiple-output (MIMO) wireless network, and may support single-user MIMO (SU-MIMO) and multi-user (MU-MIMO) communications. Further, although the wireless system 100 is depicted in FIG. 1 as an infrastructure Basic Service Set (BSS), in other implementations, the wireless system 100 may be an Independent Basic Service Set (IBSS), an Extended Basic Service Set, an ad-hoc network, a peer-to-peer (P2P) network (such as operating according to the Wi-Fi Direct protocols), or a mesh network. Thus, for at least some implementations, the AP 110, the STA 120, and the IoT devices 130a-130i can communicate with each other using multiple wireless communication protocols (such as Wi-Fi signals and Bluetooth signals).

The STA 120 may be any suitable Wi-Fi enabled wireless device including, for example, a cell phone, personal digital assistant (PDA), tablet device, laptop computers, or the like. The STA 120 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, STA 120 may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below.

Each of IoT devices 130a-130i may be any suitable device capable of operating according to one or more communication protocols associated with IoT systems. For example, the IoT devices 130a-130i can be a smart television, a smart appliance, a smart meter, a smart thermostat, a sensor, a gaming console, a set-top box, a smart light switch, and the like. In some implementations, the IoT devices 130a-130i can wirelessly communicate with each other, mobile station, access points, and other wireless devices using Wi-Fi signals, Bluetooth signals, and WiGig signals. For at least some implementations, each of IoT devices 130a-130i may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below. In some implementations, each of the IoT devices 130a-130i may include fewer wireless transmission resources than the STA 120. Another distinction between STA 120 and the IoT devices 130a-130i may be that the IoT devices 130a-130i typically communicate with other wireless devices using relatively narrow channel widths (such as to reduce power consumption), while the STA 120 typically communicates with other wireless devices using relatively wide channel widths (such as to maximize data throughput). In some aspects, the IoT devices 130a-130i may communicate using narrowband communication protocols such as Bluetooth Low Energy (BLE). The capability of a device to operate an as IoT may be made possible by electronically attaching a transceiver card to the device. The transceiver card may be removable, and thus allowing the device to operate as an IoT for the time that the transceiver card is operating and interacting with the device and other IoT devices. For example, a television set with receptors to receive electronically such a transceiver card may be operate as an IoT when such a transceiver card has been attached and operating to communicate wireless signals with other IoT devices.

The AP 110 may be any suitable device that allows one or more wireless devices to connect to a network (such as a local area network (LAN), wide area network (WAN), metropolitan area network (MAN), or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (such as one or more nonvolatile memory elements, such as EPROM, EEPROM, Flash memory, a hard drive, etc.) that stores instructions for performing operations described below. For other implementations, one or more functions of AP 110 may be performed by the STA 120 (such as operating as a soft AP). A system controller 140 may provide coordination and control for the AP 110 and/or for other APs within or otherwise associated with the wireless system 100 (other access points not shown for simplicity).

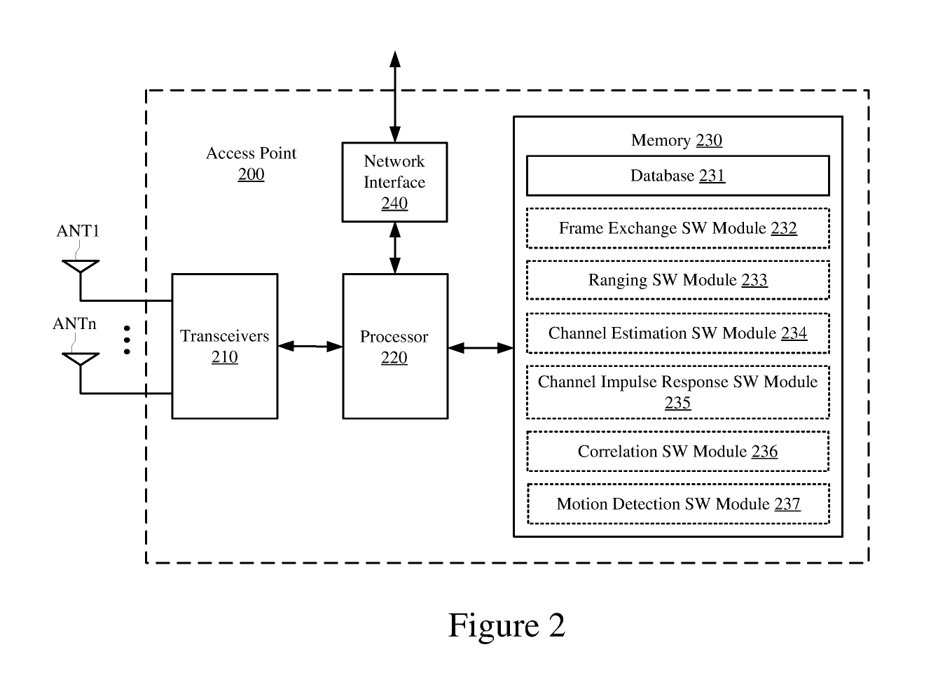

FIG. 2 shows an example access point 200. The access point (AP) 200 may be one implementation of the AP 110 of FIG. 1. The AP 200 may include one or more transceivers 210, a processor 220, a memory 230, a network interface 240, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from other wireless devices including, for example, the IoT devices 130a-130i and STA 120 of FIG. 1, or other suitable wireless devices. Although not shown in FIG. 2 for simplicity, the transceivers 210 may include any number of transmit chains to process and transmit signals to other wireless devices via antennas ANT1-ANTn, and may include any number of receive chains to process signals received from antennas ANT1-ANTn. Thus, the AP 200 may be configured for MIMO operations. The MIMO operations may include SU-MIMO operations and MU-MIMO operations. Further, in some aspects, the AP 200 may use multiple antennas ANT1-ANTn to provide antenna diversity. Antenna diversity may include polarization diversity, pattern diversity, and spatial diversity.

For purposes of discussion herein, processor 220 is shown as coupled between transceivers 210 and memory 230. For actual implementations, transceivers 210, processor 220, the memory 230, and the network interface 240 may be connected together using one or more buses (not shown for simplicity). The network interface 240 can be used to connect the AP 200 to one or more external networks, either directly or through the system controller 140 of FIG. 1.

Memory 230 may include a database 231 that may store location data, configuration information, data rates, MAC addresses, timing information, modulation and coding schemes, and other suitable information about (or pertaining to) a number of IoT devices, stations, and other APs. The database 231 also may store profile information for a number of wireless devices. The profile information for a given wireless device may include, for example, the wireless device's service set identification (SSID), channel information, received signal strength indicator (RSSI) values, throughput values, channel state information (CSI), and connection history with the access point 200.

Memory 230 also may include a non-transitory computer-readable storage medium (such as one or more nonvolatile memory elements, such as EPROM, EEPROM, Flash memory, a hard drive, and so on) that may store the following software modules:

a frame exchange software module 232 to create and exchange frames (such as data frames, control frames, management frames, and action frames) between AP 200 and other wireless devices, for example, as described in more detail below;

a ranging software module 233 to perform a number of ranging operations with one or more other devices, for example, as described in more detail below

a channel estimation software module 234 to estimate channel conditions and to determine a channel frequency response based on wireless signals transmitted from other devices, for example, as described in more detail below;

a channel impulse response (CIR) software module 235 to determine or derive a CIR based, at least in part, on the estimated channel conditions or the channel frequency response provided by the channel estimation software module 234, for example, as described in more detail below;

a correlation software module 236 to determine an amount of correlation between a number of channel impulse responses, for example, as described in more detail below; and

a motion detection module 237 to detect or determine a presence of motion in the vicinity of the AP 200 based at least in part on the estimated channel conditions and/or the determined amount of correlation between the channel impulse responses, for example, as described in more detail below.

Each software module includes instructions that, when executed by processor 220, may cause the AP 200 to perform the corresponding functions. The non-transitory computer-readable medium of memory 230 thus includes instructions for performing all or a portion of the operations described below.

The processor 220 may be any one or more suitable processors capable of executing scripts or instructions of one or more software programs stored in the AP 200 (such as within memory 230). For example, the processor 220 may execute the frame exchange software module 232 to create and exchange frames (such as data frames, control frames, management frames, and action frames) between AP 200 and other wireless devices. The processor 220 may execute the ranging software module 233 to perform a number of ranging operations with one or more other devices. The processor 220 may execute channel estimation software module 234 to estimate channel conditions and to determine a channel frequency response of wireless signals transmitted from other devices. The processor 220 may execute the channel impulse response software module 235 to determine or derive a CIR based, at least in part, on the estimated channel conditions or the channel frequency response provided by the channel estimation software module 234. The processor 220 may execute the correlation software module 236 to determine an amount of correlation between a number of channel impulse responses. The processor 220 may execute the motion software detection module 237 to detect or determine a presence of motion in the vicinity of the AP 200 based at least in part on the estimated channel conditions or the determined amount of correlation between the channel impulse responses.

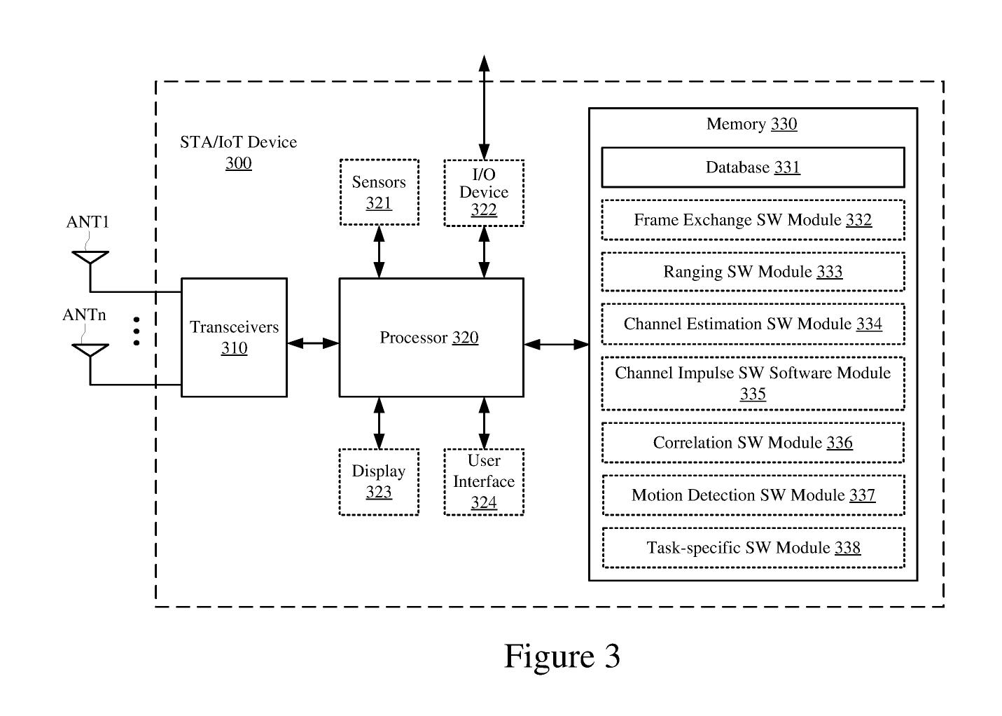

FIG. 3 shows an example block diagram for STA 120 and IoT device 300. The STA/IoT device 300 may be one implementation of STA 120 and the IoT devices 130a-130i of FIG. 1. The STA/IoT device 300 includes one or more transceivers 310, a processor 320, a memory 330, and a number of antennas ANT1-ANTn. The transceivers 310 may be coupled to antennas ANT1-ANTn, either directly or through an antenna selection circuit (not shown for simplicity). The transceivers 310 may be used to transmit signals to and receive signals from APs, STAs, other IoT devices, or any other suitable wireless device. Although not shown in FIG. 3 for simplicity, the transceivers 310 may include any number of transmit chains to process and transmit signals to other wireless devices via antennas ANT1-ANTn, and may include any number of receive chains to process signals received from antennas ANT1-ANTn. For purposes of discussion herein, processor 320 is shown as coupled between transceivers 310 and memory 330. For actual implementations, transceivers 310, processor 320, and memory 330 may be connected together using one or more buses (not shown for simplicity).

The STA/IoT device 300 may optionally include one or more of sensors 321, an input/output (I/O) device 322, a display 323, a user interface 324, and any other suitable component. For one example in which STA/IoT device 300 is a smart television, the display 323 may be a TV screen, the I/O device 324 may provide audio-visual inputs and outputs, the user interface 324 may be a control panel, a remote control, and so on. For another example in which STA/IoT device 300 is a smart appliance, the display 323 may provide status information, and the user interface 324 may be a control panel to control operation of the smart appliance. The functions performed by such IoT devices may vary in complexity and function. As such, one or more functional blocks shown in STA/IoT device 300 may not be present and/or additional functional blocks may be present. The IoT device may be implemented with minimal hardware and software complexity. For example, the IoT device functioning as a light switch may have far less complexity than the IoT device implemented for a smart television. Moreover, any possible device may be converted into an IoT device by electronically connecting to a removable electronic card which includes one or more functionalities shown in FIG. 3. The device would functionally interact with the electronic card. For example, an older generation television set could be converted to a smart television by inserting the electronic card in an input port of the television, and allowing the electronic card to interact with the operation of the television.

Memory 330 may include a database 331 that stores profile information for a plurality of wireless devices such as APs, stations, and/or other IoT devices. The profile information for a particular AP may include information including, for example, the AP's SSID, MAC address, channel information, RSSI values, certain parameters values, channel state information (CSI), supported data rates, connection history with the AP, a trustworthiness value of the AP (e.g., indicating a level of confidence about the AP's location, etc.), and any other suitable information pertaining to or describing the operation of the AP. The profile information for a particular IoT device or station may include information including, for example, device's MAC address, IP address, supported data rates, and any other suitable information pertaining to or describing the operation of the device.

Memory 330 also may include a non-transitory computer-readable storage medium (such as one or more nonvolatile memory elements, such as EPROM, EEPROM, Flash memory, a hard drive, and so on) that may store the following software (SW) modules:

a frame exchange software module 332 to create and exchange frames (such as data frames, control frames, management frames, and action frames) between the STA/IoT device 300 and other wireless devices, for example, as described in more detail below;

a ranging software module 333 to perform a number of ranging operations with one or more other devices, for example, as described in more detail below

a channel estimation software module 334 to estimate channel conditions and to determine a channel frequency response based on wireless signals transmitted from other devices, for example, as described in more detail below;

a channel impulse response software module 335 to determine or derive a channel impulse response based, at least in part, on the estimated channel conditions and/or the channel frequency response provided by the channel estimation software module 334, for example, as described in more detail below;

a correlation software module 336 to determine an amount of correlation between a number of channel impulse responses, for example, as described in more detail below;

a motion detection software module 337 to detect or determine a presence of motion in the vicinity of the STA/IoT device 300 based at least in part on the estimated channel conditions and/or the determined amount of correlation between the channel impulse responses, for example, as described in more detail below; and

a task-specific software module 338 to facilitate the performance of one or more tasks that may be specific to IoT device 300.

Each software module includes instructions that, when executed by processor 320, may cause the STA/IoT device 300 to perform the corresponding functions. The non-transitory computer-readable medium of memory 330 thus includes instructions for performing all or a portion of the operations described below.

The processor 320 may be any one or more suitable processors capable of executing scripts or instructions of one or more software programs stored in the STA/IoT device 300 (such as within memory 330). For example, the processor 320 may execute the frame exchange software module 332 to create and exchange frames (such as data frames, control frames, management frames, and action frames) between the STA/IoT device 300 and other wireless devices. The processor 320 may execute the ranging software module 333 to perform a number of ranging operations with one or more other devices. The processor 320 may execute channel estimation software module 334 to estimate channel conditions and to determine a channel frequency response of wireless signals transmitted from other devices. The processor 320 may execute the channel impulse response software module 335 to determine or derive a CIR based, at least in part, on the estimated channel conditions and/or the channel frequency response provided by the channel estimation software module 334. The processor 320 may execute the correlation software module 336 to determine an amount of correlation between a number of channel impulse responses. The processor 320 may execute the motion software detection module 337 to detect or determine a presence of motion in the vicinity of the STA/IoT device 300 based at least in part on the estimated channel conditions or the determined amount of correlation between the channel impulse responses.

The processor 320 may execute the task-specific software module 338 to facilitate the performance of one or more tasks that may be specific to the STA 120 and IoT device 300. For one example in which STA/IoT device 300 is a smart TV, execution of the task specific software module 338 may cause the smart TV to turn on and off, to select an input source, to select an output device, to stream video, to select a channel, and so on. For another example in which STA/IoT device 300 is a smart thermostat, execution of the task specific software module 338 may cause the smart thermostat to adjust a temperature setting in response to one or more signals received from a user or another device. For another example in which STA/IoT device 300 is a smart light switch, execution of the task specific software module 338 may cause the smart light switch to turn on/off or adjust a brightness setting of an associated light in response to one or more signals received from a user or another device. In some implementations, execution of the task-specific software module 338 may cause the STA/IoT device 300 to turn on and off based on a detection of motion, for example, by the motion detection software module 337.

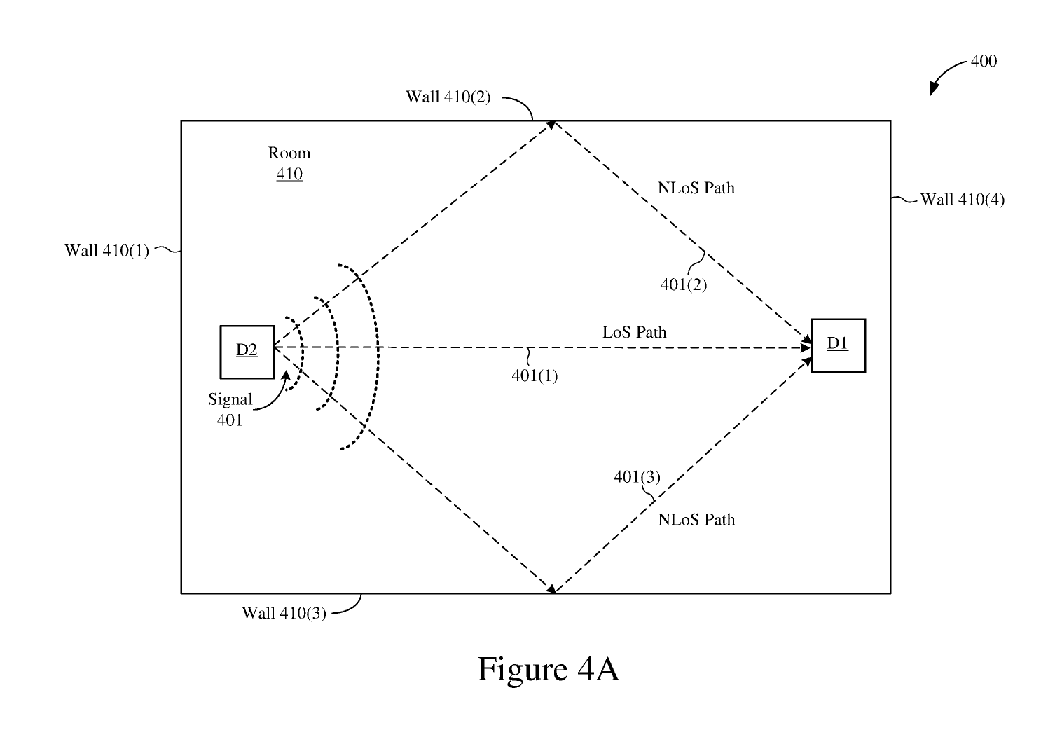

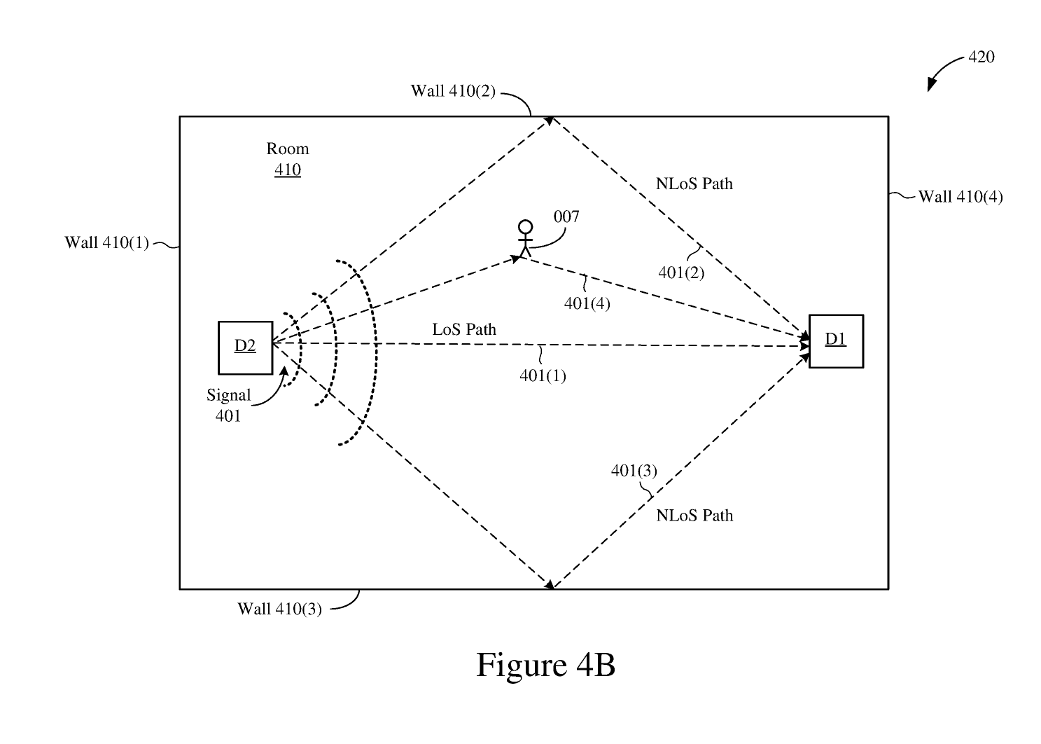

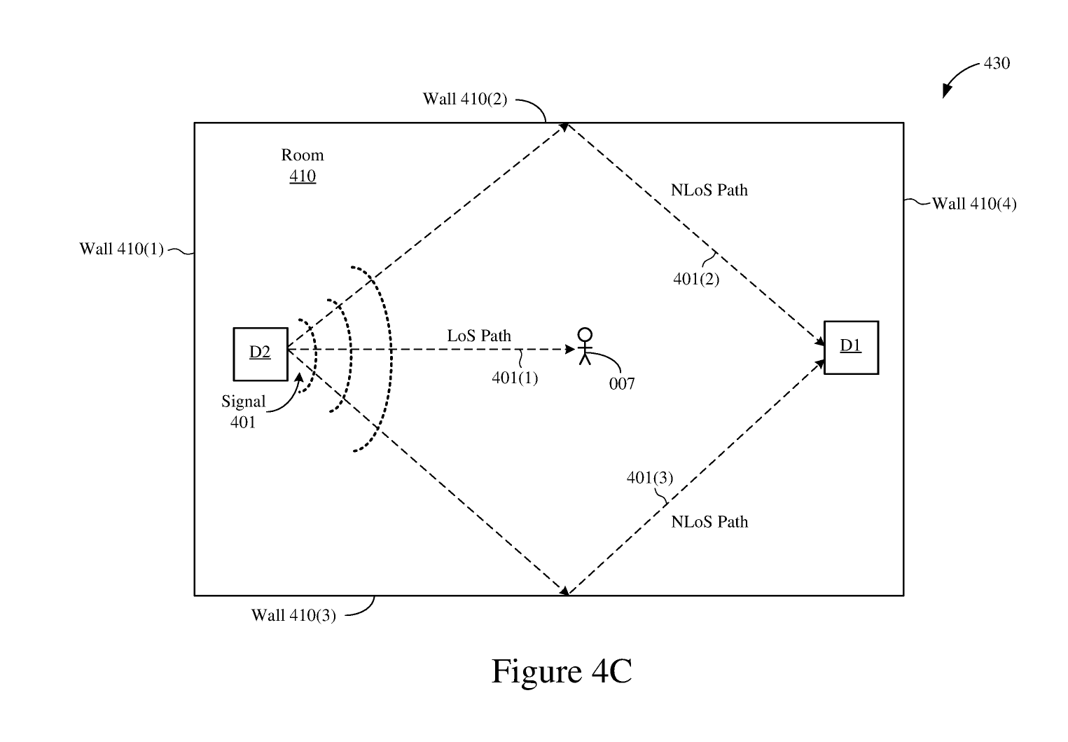

FIG. 4A shows a transmission of a multipath wireless signal in a room 410 without motion. As depicted in FIG. 4A, a first device D1 receives a wireless signal 401 transmitted from a second device D2. The wireless signal 401 may be any suitable wireless signal from which channel conditions can be estimated including, for example, a data frame, a beacon frame, a probe request, an ACK frame, a timing measurement (TM) frame, a fine timing measurement (FTM) frame, a null data packet, and so on. In a signal propagation space where objects and/or walls are in the vicinity of the source of the signal transmission, certain multipath effect would be experienced. The receiving end of the signal would invariably experience receiving the transmitted signal through such multipath effect. In the example of room 410, the wireless signal 401 may be influenced by multipath effects. The effects may be due, for example, from at least walls 410(2 and 3) and other obstacles and objects, such as furniture. For simplicity, the multipath effect is shown to produce a first signal component 401(1), a second signal component 401(2), and a third signal component 401(3). The first signal component 401(1) travels directly from device D2 to device D1 along a line-of-signal (LOS) path, the second signal component 401(2) travels indirectly from device D2 to device D1 along a non-LOS (NLOS) path that reflects off wall 410(2), and the third signal component 401(3) travels indirectly from device D2 to device D1 along a NLOS path that reflects off wall 410(3). As a result, the first signal component 401(1) may arrive at device D1 at different times or at different angles compared to the second signal component 401(2) or the third signal component 401(3).

It is noted that although only two NLOS signal paths are depicted in FIG. 4A, the wireless signal 401 may have any number of signal components that travel along any number of NLOS paths between device D2 and device D1. Further, although the first signal component 401(1) is depicted as being received by device D1 without intervening reflections, for other examples, the first signal component 401(1) may be reflected one or more times before received by device D1.

As mentioned above, it would be desirable for device D1 to detect motion in its vicinity (such as within the room 410) without using a separate or dedicated motion sensor. Thus, in accordance with various aspects of the present disclosure, device D1 can use the wireless signal 401 transmitted from device D2 to detect motion within the room 410. More specifically, device D1 can estimate channel conditions based at least in part on the wireless signal 401, and then detect motion based at least in part on the estimated channel conditions. Thereafter, device D1 can perform a number of operations based on the detected motion. For example, device D1 can turn itself on when motion is detected, and can turn itself off when motion is not detected for a time period. In yet another example, it may simply alert a user about detection of motion in room 410.

As depicted in FIG. 4A, the wireless signal 410 includes multipath signals associated with multiple arrival paths. As a result, the detection of motion in room 410 may be based on at least one characteristic of the multipath signals. For purposes of discussion herein, there is no motion in room 410 at the time depicted in FIG. 4A (such as a night when no one is in the room or during times when no one is at home or walking through room 410). For purposes of discussion herein, the signal propagation of the room 410 depicted in FIG. 4A may be associated with an observation at a first time T1 when no motion is expected to be occurring in room 410. In some implementations, device D1 estimates channel conditions when there is no motion in room 410, and then designates these estimated channel conditions as reference channel conditions. The reference channel conditions can be stored in device D1 or in any other suitable device coupled to device D1, for example, as occurring at the first time T1. It is noted that device D1 can estimate or determine the reference channel conditions continuously, periodically, randomly, or at one or more specified times (such as when there is no motion in the room 410).

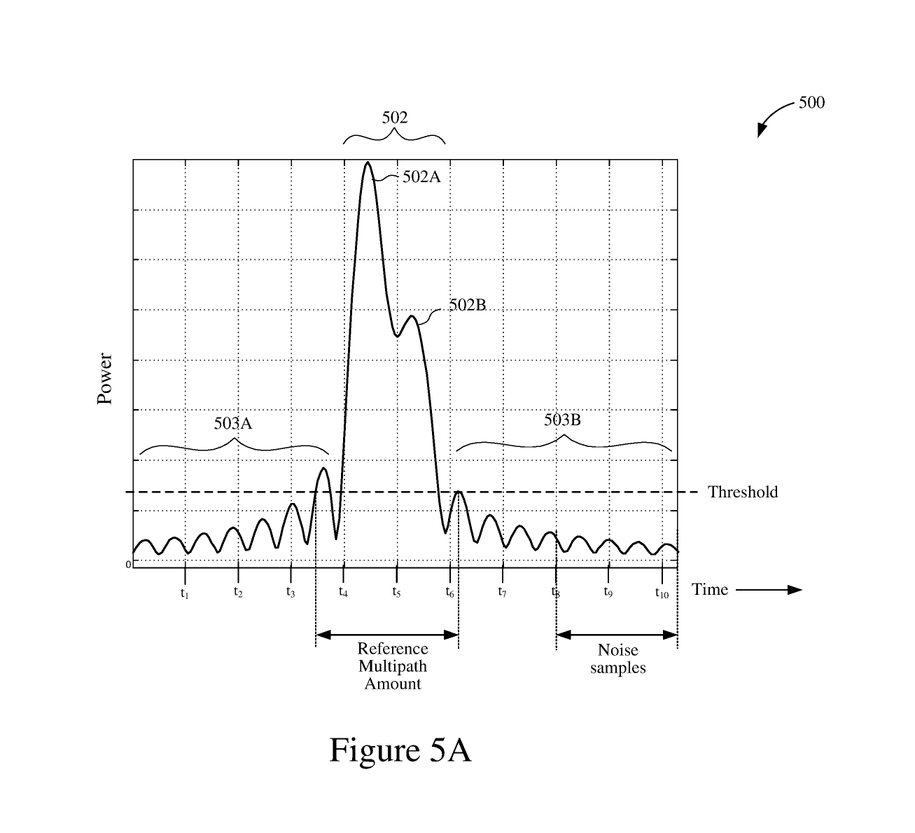

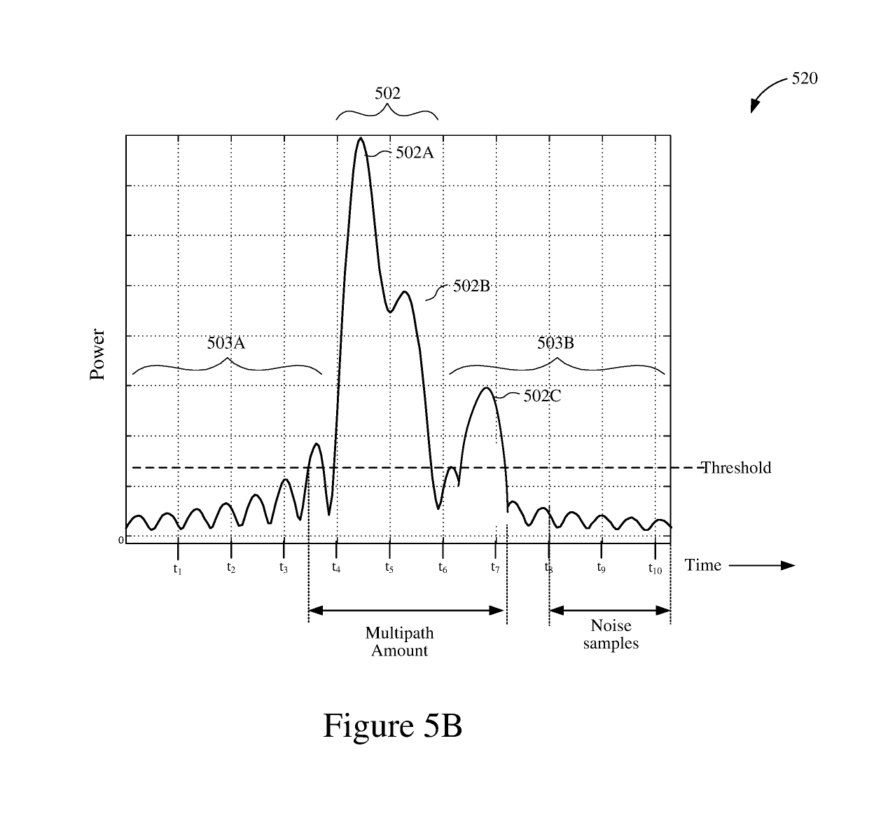

FIG. 5A shows an example channel impulse response (CIR) 500 of the wireless signal 401 of FIG. 4A. The channel impulse response 500 may be expressed in terms of power (y-axis) as a function of time (x-axis). As described above with respect to FIG. 4A, the wireless signal 401 includes line-of-sight (LOS) signal components and non-LOS (NLOS) signal components, and is received by device D1 in the presence of multipath effects. In some implementations, device D1 may determine the CIR 500 by taking an Inverse Fourier Transfer (IFT) function of a channel frequency response of the received wireless signal 401. Thus, in some aspects, the channel impulse response 500 may be a time-domain representation of the wireless signal 401 of FIG. 4A. Because the wireless signal 401 of FIG. 4A includes an LOS signal component 401(1) and a number of NLOS signal components 401(2)-401(3), the CIR 500 of FIG. 5A may be a superposition of multiple sinc pulses, each associated with a corresponding peak or “tap” at a corresponding time value.

More specifically, the CIR 500 is shown to include a main lobe 502 occurring between approximately times t4 and t6, and includes a plurality of secondary lobes 503A and 503B on either side of the main lobe 502. The main lobe 502 includes a first peak 502A and a second peak 502B of different magnitudes, for example, caused by multipath effects. The first peak 502A, which has a greater magnitude than the second peak 502B, may represent the signal components traveling along the first arrival path (FAP) to device D1 of FIG. 4A. In some aspects, the main peak 502A can be the first arrival in the CIR 500, and can represent the LOS signal components as well as one or more NLOS signal components that may arrive at device D1 at the same time (or nearly the same time) as the LOS signal components. The taps associated with secondary lobes 503A and 503B can be later arrivals in the CIR 500, and can represent the NLOS signal components arriving at device D1.

As shown in FIG. 5A, a threshold power level may be selected, and the portion of the CIR 500 that exceeds the threshold power level may be designated as the amount of multipath. In other words, for the example of FIG. 5A, the amount of multipath may be expressed as the duration of the CIR 500 that exceeds the threshold power level. Portions of the CIR 500 associated with later signal arrivals that fall below the threshold power level may be designated as noise samples in sampling of the incoming signal. The amount of multipath determined from the CIR 500 of FIG. 5A may be stored in device D1 (or another suitable device) and thereafter used to detect motion in the room 410 at other times.

In some aspects, the amount of multipath can be measured as the Root Mean Square (RMS) of channel delay (such as the duration of multipath longer than a threshold). It is noted that the duration of the multipath is the width (or time delay) of the entire CIR 500; thus, while only portions of the CIR corresponding to the first arrival path are typically used when estimating angle information of wireless signal, the entire CIR 500 may be used when detecting motion as disclosed herein. The threshold power level can be set according to either the power level of the strongest signal path power or to the noise power or both.

The device D1 can use the reference multipath amount determined at time T1 to detect motion in the room at one or more later times. For example, FIG. 4B shows the transmission of a multipath wireless signal in the room 410 with motion. For purposes of discussion herein, the room 410 depicted in FIG. 4B may be associated with multipath signal propagation occurring at a second time T2. As depicted in FIG. 4B, a person 007 has entered the room 410 and caused at least an additional NLOS signal 401(4). The additional NLOS signal 401(4) resulting from the presence or movement of person 007 may change the channel conditions, for example, as compared to the channel conditions of the room 410 at the first time T1 (as depicted in FIG. 4A). In accordance with various aspects of the present disclosure, device D1 can use changes in estimated channel conditions between times T1 and T2 to detect movement of an object/person (motion) in the room 410. More specifically, device D1 can estimate channel conditions based on the signal 401 of FIG. 4B (which include the “new” NLOS signal 401(4)), and then compare the estimated channel conditions at the second time T2 with the reference channel conditions estimated at the first time T1.

FIG. 5B shows an example CIR 520 of the wireless signal 401 at time T2, as depicted in FIG. 4B. The CIR 520 is similar to the CIR 500 of FIG. 5A, except that the multipath amount at time T2 is greater (such as having a longer duration) than the reference multipath amount depicted in FIG. 5A, and there is an extra peak 502C corresponding to the NLOS signal 401(4) caused by the presence or movement of person 007 in room 410. Thus, in some aspects, the change in multipath amount between time T1 and time T2 can be used to detect motion in the vicinity of device D1 (such as in the room 410).

FIG. 4C shows the transmission of a multipath wireless signal in the room 410 when the person 007 obstructs the LOS signal 401(1). For purposes of discussion herein, the room 410 depicted in FIG. 4C may be associated with a third time T3. As shown in FIG. 4C, the location of the person 007 may prevent the wireless signal 401 from having a LOS signal component 401(1) that reaches device D1. The absences of the LOS signal component 401(1) may cause the channel conditions at time T3 to be different from the channel conditions at time T2 (see FIG. 4B) and to be different from the channel conditions at time T1 (see FIG. 4A). Device D1 can use changes in estimated channel conditions between either times T1 and T3 or between times T2 and T3 (or a combination of both) to detect motion in the room 410. Thus, in some aspects, device D1 can estimate channel conditions based on the signal 401 of FIG. 4C, and then compare the estimated channel conditions at time T3 with the reference channel conditions estimated at time T1 to detect motion. In other aspects, device D1 can estimate channel conditions based on the signal 401 of FIG. 4C, and then compare the estimated channel conditions at time T3 with the channel conditions estimated at time T2 to detect motion.

In other implementations, device D1 can use the first arrival path (FAP) of the CIR 520 to detect motion when the person 007 blocks the LOS signal components, for example, as depicted in FIG. 4C. More specifically, device D1 can determine whether the power level of the FAP signal component has changed by more than a threshold value, for example, by comparing the power level of the FAP signal component of the CIR at time T1 with the power level of the FAP signal component of the CIR at time T3. In some aspects, device D1 can compare the absolute power levels of the FAP between time T1 and time T3.

In other aspects, device D1 can compare relative power levels of the FAP between time T1 and time T3. More specifically, device D1 can compare the power level of the FAP relative to the entire channel power level to determine a relative power level for the FAP signal components. By comparing relative power levels (rather than absolute power levels), the overall channel power can be normalized, for example, to compensate for different receive power levels at time T1 and time T3. For example, even though the person 007 is not obstructing the LOS signal (as depicted in FIG. 4B at time T2), it is possible that the overall receive power level may be relatively low. Conversely, even though the person 007 obstructs the LOS signal (as depicted in FIG. 4C at time T3), it is possible that the overall power level may be relatively high.

In some other implementations, device D1 can compare the shapes of channel impulse responses determined at different times to detect motion. For example, device D1 can compare the shape of CIR 500 (determined at time T1) with the shape of CIR 520 (determined at time T2) by determining a correlation between the channel impulse responses 500 and 520. In some aspects, device D1 can use a covariance matrix to determine the correlation between the channel impulse responses 500 and 520. In other aspects, device D1 can perform a sweep to determine a correlation between a number of identified peaks of the CIR 500 and a number of identified peaks of the CIR 520, and then determine whether the identified peaks of the CIR 500 are greater in power than the identified peaks of the CIR 520. Further, if motion is detected, then device D1 can trigger additional motion detection operations to eliminate false positives and/or to update reference information (such as the reference multipath amount).

In addition, or in the alternative, device D1 can base a detection of motion on comparisons between FAP power levels and comparisons of multipath amounts.

In accordance with other aspects of the present disclosure, device D1 can solicit the transmission of one or more wireless signals from device D2, for example, rather than waiting to receive wireless signals transmitted from another device (such as device D2 in the examples of FIGS. 4A-4C). In some aspects, device D1 can initiate an active ranging operation to solicit a response frame from device D2, use the received response frame to estimate channel conditions, and thereafter detect motion based on the estimated channel conditions.

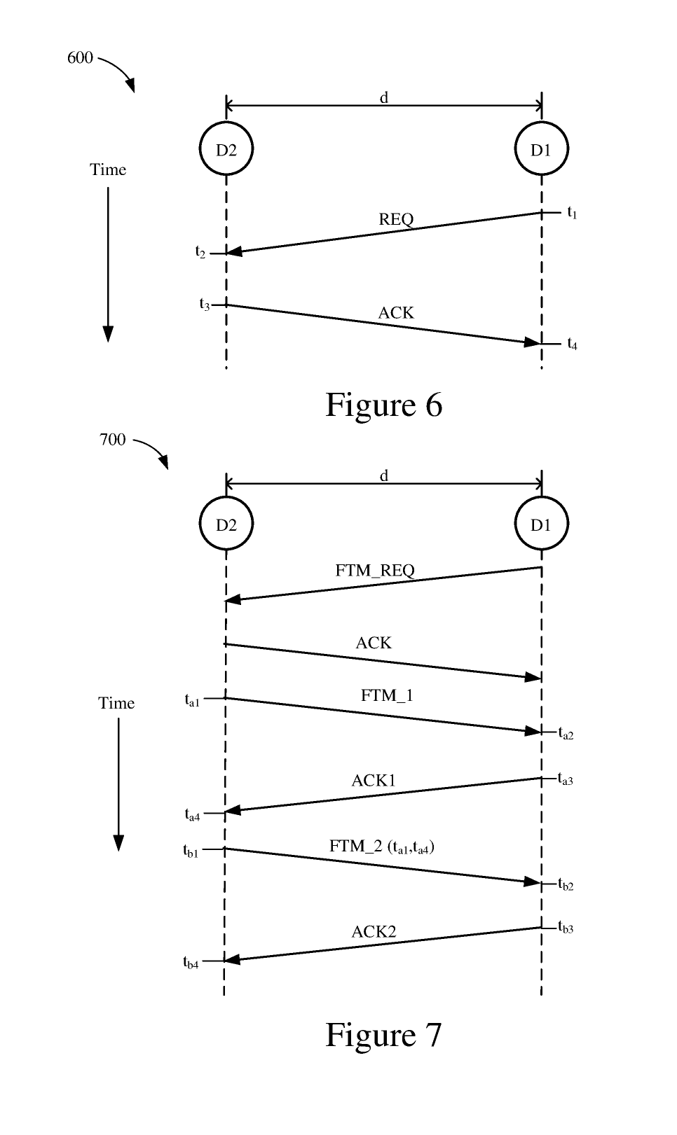

FIG. 6 shows a signal diagram of an example ranging operation 600. The example ranging operation 600, which is performed between the first and second devices D1 and D2, may be used to detect motion in the vicinity of the first device D1. In some implementations, the first device D1 is an IoT device (such as one of IoT devices 130a-130i of FIG. 1 or the STA/IoT device 300 of FIG. 3), and the second device D2 is an AP (such as the AP 110 of FIG. 1 or the AP 200 of FIG. 2). For example, device D1 may be a smart television located in the room 410 depicted in FIGS. 4A-4C, and device D2 may be an access point located in the room 410 depicted in FIGS. 4A-4C. In other implementations, each of the first and second devices D1 and D2 may be any suitable wireless device (such as a STA, an AP, or an IoT device). For the ranging operation 600 described below, device D1 is the initiator device (also known as the “requester device”), and the device D2 is the responder device.

At time t1, device D1 transmits a request (REQ) frame to device D2, and device D2 receives the REQ frame at time t2. The REQ frame can be any suitable frame that solicits a response frame from device D2 including, for example, a data frame, a probe request, a null data packet (NDP), and so on. At time t3, device D2 transmits an acknowledgement (ACK) frame to device D1, and device D1 receives the ACK frame at time t4. The ACK frame can be any frame that is transmitted in response to the REQ frame.

After the exchange of the REQ and ACK frames, device D1 may estimate channel conditions based at least in part on the ACK frame received from device D2. Then, device D1 may detect motion based at least in part on the estimated channel conditions. In some aspects, device D1 may use the estimated channel conditions to determine a channel frequency response (based on the ACK frame), and may then determine a CIR based on the channel frequency response (such as by taking an IFT function of the channel frequency response).

For at least some implementations, device D1 may capture the time of departure (TOD) of the REQ frame, device D2 may capture the time of arrival (TOA) of the REQ frame, device D2 may capture the TOD of the ACK frame, and device D2 may capture the TOA of the ACK frame. Device D2 may inform device D1 of the time values for t2 and t3, for example, so that device D1 has timestamp values for t1, t2, t3, and t4. Thereafter, device D1 may calculate the round trip time (RTT) value of the exchanged FTM_REQ frame and ACK frames as RTT=(t4−t3)+(t2−t1). The distance (d) between the first device D1 and the second device D2 may be estimated as d=c*RTT/2, where c is the speed of light.

FIG. 7 shows a signal diagram of an example ranging operation 700. The example ranging operation 700, which is performed between first and second devices D1 and D2, may be used to detect motion in the vicinity of the first device D1. In some implementations, the first device D1 is an IoT device (such as one of IoT devices 130a-130i of FIG. 1 or the STA/IoT device 300 of FIG. 3), and the second device D2 is an AP (such as the AP 110 of FIG. 1 or the AP 200 of FIG. 2). For example, device D1 may be a smart television located in the room 410 depicted in FIGS. 4A-4C, and device D2 may be an access point located in the room 410 depicted in FIGS. 4A-4C. In other implementations, each of the first and second devices D1 and D2 may be any suitable wireless device (such as a STA, an AP, or an IoT device). For the ranging operation 700 described below, device D1 is the initiator device (also known as the “requester device”), and the device D2 is the responder device.

Device D1 may request or initiate the ranging operation 700 by transmitting a fine timing measurement (FTM) request (FTM_REQ) frame to device D2. Device D1 may use the FTM_REQ frame to negotiate a number of ranging parameters with device D2. For example, the FTM_REQ frame may specify at least one of a number of FTM bursts, an FTM burst duration, and a number of FTM frame exchanges per burst. In addition, the FTM_REQ frame may also include a request for device D2 to capture timestamps (e.g., TOA information) of frames received by device D2 and to capture timestamps (e.g., TOD information) of frames transmitted from device D2.

Device D2 receives the FTM_REQ frame, and may acknowledge the requested ranging operation by transmitting an acknowledgement (ACK) frame to device D1. The ACK frame may indicate whether device D2 is capable of capturing the requested timestamps. It is noted that the exchange of the FTM_REQ frame and the ACK frame is a handshake process that not only signals an intent to perform a ranging operation but also allows devices D1 and D2 to determine whether each other supports capturing timestamps.

At time ta1, device D2 transmits a first FTM (FTM_1) frame to device D1, and may capture the TOD of the FTM_1 frame as time ta1. Device D1 receives the FTM_1 frame at time ta2, and may capture the TOA of the FTM_1 frame as time ta2. Device D1 responds by transmitting a first FTM acknowledgement (ACK1) frame to device D2 at time ta3, and may capture the TOD of the ACK1 frame as time ta3. Device D2 receives the ACK1 frame at time ta4, and may capture the TOA of the ACK1 frame at time ta4. At time tb1, device D2 transmits to device D1 a second FTM (FTM_2) frame. Device D1 receives the FTM_2 frame at time tb2, and may capture its timestamp as time tb2.

In some implementations, device D1 may estimate channel conditions based on one or more of the FTM frames transmitted from device D2. Device D1 may use the estimated channel conditions to detect motion in its vicinity, for example, as described above with respect to FIGS. 4A-4C and FIGS. 5A-5B. In addition, device D2 may estimate channel conditions based on one or more of the ACK frames transmitted from device D1. Device D2 may use the estimated channel conditions to detect motion in its vicinity, for example, as described above with respect to FIGS. 4A-4C and FIGS. 5A-5B. In some aspects, device D2 may inform device D1 whether motion was detected in the vicinity of device D2 by providing an indication of detected motion in one or more of the FTM frames. In some aspects, device D2 may use a reserved bit in the FTM_1 frame or the FTM_2 frame to indicate whether device D2 detected motion.

In addition, the FTM_2 frame may include the timestamps captured at times ta1 and ta4 (e.g., the TOD of the FTM_1 frame and the TOA of the ACK1 frame). Thus, upon receiving the FTM_2 frame at time tb2, device D1 has timestamp values for times ta1, ta2, ta3, and ta4 that correspond to the TOD of the FTM_1 frame transmitted from device D2, the TOA of the FTM_1 frame at device D1, the TOD of the ACK1 frame transmitted from device D1, and the TOA of the ACK1 frame at device D2, respectively. Thereafter, device D1 may determine a first RTT value as RTT1=(ta4−ta3)+(ta2−ta1). Because the value of RTT1 does not involve estimating SIFS for either device D1 or device D2, the value of RTT1 does not involve errors resulting from uncertainties of SIFS durations. Consequently, the accuracy of the resulting estimate of the distance between devices D1 and D2 is improved (e.g., as compared to the ranging operation 600 of FIG. 6).

Although not shown in FIG. 7 for simplicity, devices D1 and D2 may exchange additional pairs of FTM and ACK frames, for example, where device D2 embeds the timestamps of a given FTM and ACK frame exchange into a subsequent FTM frame transmitted to device D1. In this manner, device D1 may determine an additional number of RTT values.

The accuracy of RTT and channel estimates between wireless devices may be proportional to the frequency bandwidth (the channel width) used for transmitting the FTM and ACK frames. As a result, ranging operations for which the FTM and ACK frames are transmitted using a relatively large frequency bandwidth may be more accurate and may provide better channel estimates than ranging operations for which the FTM and ACK frames are transmitted using a relatively small frequency bandwidth. For example, ranging operations performed using FTM frame exchanges on an 80 MHz-wide channel provide more accurate channel estimates than ranging operations performed using FTM frame exchanges on a 40 MHz-wide channel, which in turn provide more accurate channel estimates than ranging operations performed using FTM frame exchanges on a 20 MHz-wide channel.

Because Wi-Fi ranging operations may be performed using frames transmitted as orthogonal frequency-division multiplexing (OFDM) symbols, the accuracy of RTT estimates may be proportional to the number of tones (such as the number of OFDM sub-carriers) used to transmit the ranging frames. For example, while a legacy (such as non-HT) frame may be transmitted on a 20 MHz-wide channel using 52 tones, an HT frame or VHT frame may be transmitted on a 20 MHz-wide channel using 56 tones, and an HE frame may be transmitted on a 20 MHz-wide channel using 242 tones. Thus, for a given frequency bandwidth or channel width, FTM ranging operations performed using HE frames provide more accurate channel estimates than FTM ranging operations performed using VHT frames, FTM ranging operations performed using HE frames provide more accurate channel estimates than FTM ranging operations performed using VHT frames, and FTM ranging operations performed using HE frames provide more accurate channel estimates than FTM ranging operations performed using VHT frames.

Thus, in some implementations, the ACK frames of the example ranging operation 700 may be one of a high-throughput (HT) frame, a very high-throughput (VHT) frame, or a high-efficiency (HE) frame, for example, so that device D1 can estimate channel conditions over a wider bandwidth as compared with legacy frames (such as 20 MHz-wide frames exchanged in the example ranging operation 600 of FIG. 6). Similarly, in some implementations, the FTM frames of the example ranging operation 700 may be one of a high-throughput (HT) frame, a very high-throughput (VHT) frame, or a high-efficiency (HE) frame, for example, so that device D2 can estimate channel conditions over a wider bandwidth as compared with legacy frames (such as 20 MHz-wide frames exchanged in the example ranging operation 600 of FIG. 6).

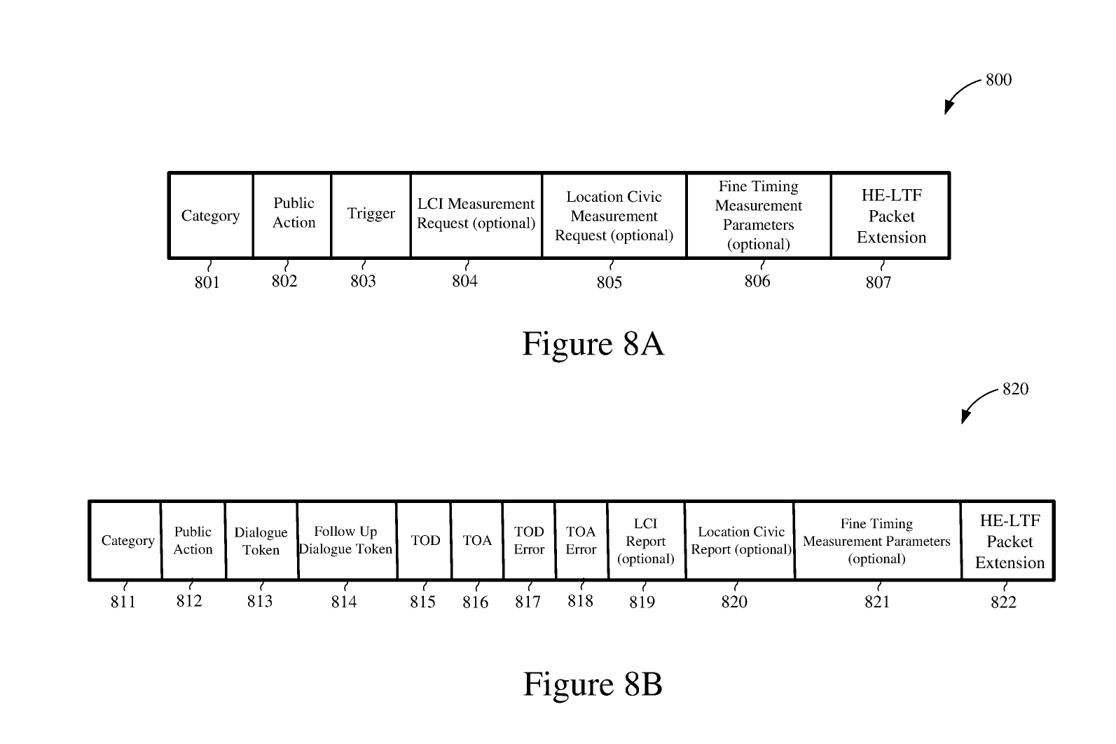

FIG. 8A shows an example FTM_REQ frame 800. The FTM_REQ frame 800 may be one implementation of the FTM_REQ frame depicted in the ranging operation 700 of FIG. 7. The FTM_REQ frame 800 may include a category field 801, a public action field 802, a trigger field 803, an optional location civic information (LCI) measurement request field 804, an optional location civic measurement request field 805, and an optional FTM parameters field 806. The fields 801-806 of the FTM_REQ frame 800 are well-known, and therefore are not discussed in detail herein. In some aspects, the FTM_REQ frame 800 may include a packet extension 807. The packet extension 807 can contain one or more sounding sequences such as, for example, HE-LTFs.

FIG. 8B depicts an example FTM frame 810. The FTM frame 810 may be one implementation of the FTM_1 and FTM_2 frames depicted in the example ranging operation of FIG. 7. The FTM frame 810 may include a category field 811, a public action field 812, a dialogue token field 813, a follow up dialog token field 814, a TOD field 815, a TOA field 816, a TOD error field 817, a TOA error field 818, an optional LCI report field 818, an optional location civic report field 820, and an optional FTM parameters field 821. The fields 811-821 of the FTM frame 810 are well-known, and therefore are not discussed in detail herein.

In some aspects, the FTM frame 810 may include a packet extension 822. The packet extension 822 may contain one or more sounding sequences such as, for example, HE-LTFs. As described above, a number of reserved bits in the TOD error field 817 and/or the TOA error field 818 of FTM frame 810 may be used to store an antenna mask.

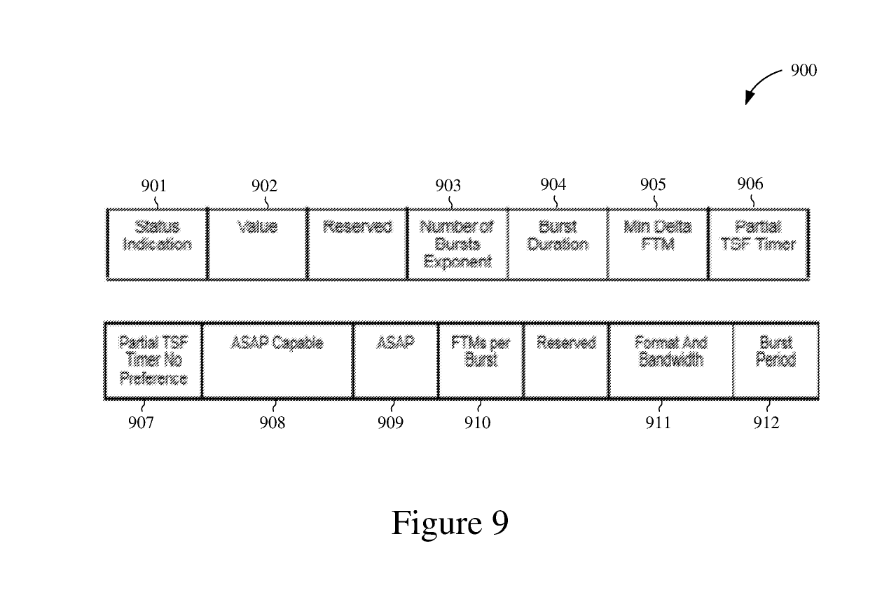

FIG. 9 shows an example FTM parameters field 900. The FTM parameters field 900 is shown to include a status indication field 901 that may be used to indicate the responding device's (such as device D2 of FIGS. 4A-4C) response to the FTM_REQ frame. The number of bursts exponent field 903 may indicate a number of FTM bursts to be included in the ranging operation of FIG. 7. The burst duration field 904 may indicate a duration of each FTM burst in the ranging operation of FIG. 7. The FTMs per burst field 910 may indicate how many FTM frames are exchanged during each burst in the ranging operation of FIG. 7. The burst period field 912 may indicate a frequency (such as how often) of the FTM bursts in the ranging operation of FIG. 7.

The environment where the measurements for determining the reference multipath amount, the multipath amount for detection of motion, and the ranging operation are performed is preferably an environment with low levels of the interference and noise. The interference and noise may be produced by the operation of the device, such as devices D1, D2 and other devices in the same general area. In case the device D1 is a smart television, the source of such a noise may be from an operation of the television. In most instances, the source of such interference and noise are not clearly known nor could be controlled in an efficient manner. In the example of a smart television, unbeknown to the user about over the air measurements, the user may turn on/off the television set, which in turn could produce unwanted noise and interference.

While referring to the graphs depicted in FIGS. 5A and 5B, the resulting measured multipath amount at times T1 and T2 may be effected by the noise generated from the device D1 or other sources. Similarly, if there is a signal interference, the resulting multipath amount would not be accurate. If additional noise is present, for example, at time T1, the measured multipath amount may be much higher because the level of the noise samples would be higher resulting in a higher multipath amount measured at time T1. Considering the noise may not be present during the measurement of the multipath amount at time T2, the level of noise samples would be lower than the levels experienced during time T1. Similarly, if there is a signal interference at either times T1 or T2, the resulting multipath amounts would not be accurate. As such, the reference multipath amount, the multipath amount for detection of motion, and the ranging operation may negatively be effected by variability of the interference in the propagation environment and presence of variable noise levels experienced by the device D1.

In accordance with various aspects of the disclosure, detection of motion relies on changes in the multipath amount as compared to the reference multipath amount. Motion by an object, for example in room 410, would cause changes in the measured multipath amount at different times (T1, T2 and T3). Motion is detected based on such changes at different times. However, there may be a room condition or certain motions where the changes in multipath amount due to motion are not reliably noticeable. For example, if the room environment is already producing signal propagation with many peaks/valley (i.e. rich multipath environment) in its reference multipath profile, the resulting reference multipath amount may determine to be at a relatively high level. In such a room environment, when the object is moving relatively close to the transmitter (device D2) or receiver (device D1), the additional multipath generated by the motion of the object may produce changes in the multipath profile that do not cause noticeable changes in the multipath amount. As such, the resulting changes in multipath amount as compared to the reference multipath amount are not reliably detectable, and the motion of the object may not be detected. In another example, if the transmitter (device D2) and the receiver (device D1) are in close proximity of each other (e.g. placed close to each other in room 410), which causes the signals in the LoS path (i.e. the direct path) to be very strong, then the reference multipath amount would be mainly dominated by the signals in the LoS path. In such a case, the additional multipath generated by the motion of the object would be much weaker than the LoS path and may not cause noticeable changes in the multipath amount and, therefore, making reliable detection of motion more difficult.

In accordance with various aspects of the disclosure, using a process involving an algorithm for managing the CIR data points of the signals received at device D1 resolves the issues with respect to reliably detecting motion in a room which produces a rich multipath profile and/or when the devices D1 and D2 are placed in a close proximity of each other. The algorithm for managing the CIR data points may be an independent process for detecting motion. The process may also be combined with the process involving determining multipath amount (as explained in relation to at least FIGS. 4A, 4B, 4C, 5A and 5B) for detecting motion. For example, when determining that the room is producing a rich multipath profile and/or the transmitter (device D2) and receiver (device D1) are in a close proximity of each other, the process involving the algorithm for managing the CIR data points of the received signals may be used for motion detection. Determining whether the environment is producing a rich multipath profile could be decided based on the level of the multipath amount. If the reference multipath amount and/or multipath amount determined for motion detection are at a high level, the environment may reliably be determined to be producing rich multipath profile. The proximity of the transmitting device (D2) and receiving device (D1) may also be determined from the signals transmitted and received in the environment as explained. Most simplistically, the distance between a transmitter and a receiver may be determined based on the received signal strength indicator (RSSI). A high level of RSSI is an indication of a close proximity of the transmitter and the receiver, and may be used very reliably to determine the proximity level of the transmitting and receiving devices (D1 and D2).

The process involving an algorithm for managing the CIR data points of the signals received at device D1 may include transmission and reception of several data packets to get a reference CIR power, and may be explained as following:
Capture temporary reference CIR for P packets to get CIR₁ to CIR_{P}. Each CIRᵢ has N samples, CIRᵢ(1:N), i=1, 2, . . . P, and each sample is a complex number with/and Q components.
Convert temporary reference CIR to temporary reference CIR power by computing I²+Q² to convert CIRᵢ to CIRᵢ^{power}, i=1, 2, . . . P. Each CIRᵢ^{power} has N samples, CIRᵢ^{power}(1:N), and each sample is a non-negative real number.
Align CIRᵢ^{power} to CIR_{P}^{power} in time to get CIRᵢ^{powerAlign} to CIR_{P}^{powerAlign}. In accordance with various aspects of the disclosure, two possible algorithms are disclosed, where each algorithm may be used to align CIR₁^{power} to CIR_{P}^{power}. Other algorithms can also be used. The Algorithm 1 is based on aligning the first peak position to occur at tap 0 in the profile of the temporary reference CIR power.

Algorithm 1 for aligning the temporary reference CIR power:
For CIRᵢ^{power}, detect the first strongest tap, say CIRᵢ^{power} (j), which satisfies that CIRᵢ^{power} (j)≥CIRᵢ^{power} (k) for any k>j and CIRᵢ^{power} (j)>CIRᵢ^{power} (p) for any p<j.
Define a first peak detection threshold Th as Th=α×CIRᵢ^{power} (j). For example, α=0.1.
Detect the first tap that is stronger than Th, say CIRᵢ^{power}(m), which satisfies that CIRᵢ^{power} (m)≥Th and CIRᵢ^{power} (n)<Th for any n<m.
Search from CIRᵢ^{power} (m) to CIRᵢ^{power} (j) to find the first peak CIRᵢ^{power}(q), which satisfies that CIRᵢ^{power}(q)≥CIRᵢ^{power}(q−1) and CIRᵢ^{power}(q)≥CIRᵢ^{power}(q+1).
Cyclically shift CIRᵢ^{power} to make q the first tap, meaning CIRᵢ^{powerAlign}=[CIRᵢ^{power} (q:N) CIRᵢ^{power}(1:q−1)].
Repeat the above steps for CIRᵢ^{power} to CIR_{P}^{power} to get CIR₁^{powerAlign} to CIR_{P}^{powerAlign}.

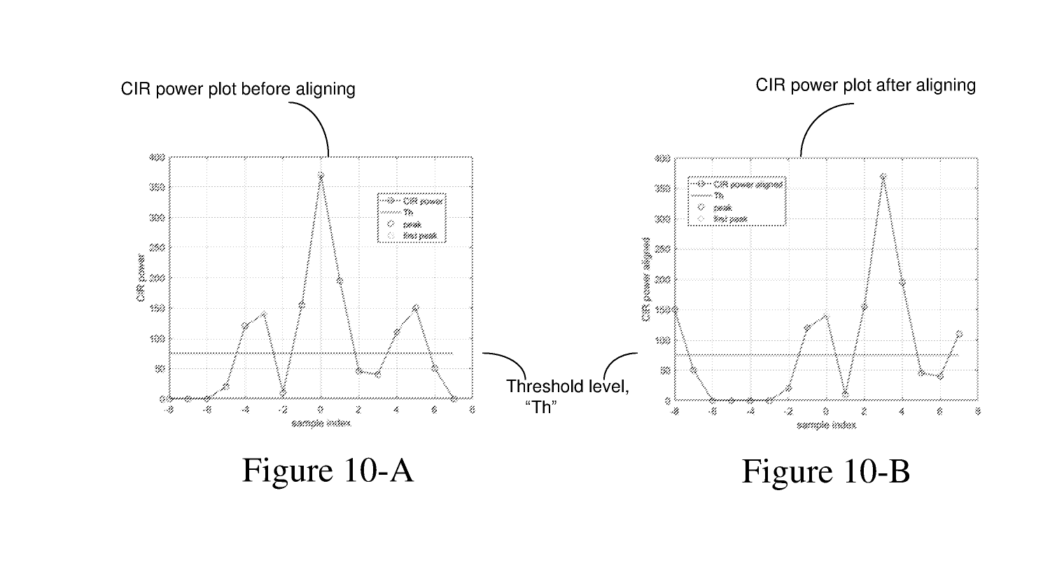

The Algorithm 1 for aligning the temporary reference CIR power may also be explained graphically by making references to the plots shown in FIG. 10. Two exemplary CIR power plots are shown, FIG. 10-A and FIG. 10-B. FIG. 10-A is before aligning and FIG. 10-B is after aligning. The Algorithm 1 may also be more apparent by the following:
Detect the tap corresponding to the strongest CIR power in the temporary reference CIR power profile, which is identified as tap 0 in FIG. 10-A.
Detect the first tap that is stronger than the threshold “Th”, which is tap −4 in FIG. 10-A.
Search from tap −4 to tap 0 to find the first peak, which has occurred at tap −3, the CIR power at tap −3 is the first peak because the level is greater than the CIR power level at taps −4 or −2.
Cyclically shift the temporary reference CIR power plot to make the tap −3 to occur at the 0 tap, as shown in FIG. 10-B.

Algorithm 2 for aligning the temporary reference CIR power is based on maximizing the cross-correlation between the temporary reference CIR power data points. The Algorithm 2 for aligning the temporary reference CIR power may be explained and apparent as following:
Use a first temporary reference CIR power CIR₁^{power} as reference.
For all other temporary reference CIR power CIRᵢ^{power}, i=2, 3, . . . , P, perform cross-correlation between CIR₁^{power} and CIRᵢ^{power}, and get cross-correlation result Corrᵢ(1:N), where Corrᵢ(t)=Σₛ₌₁^{N+1-t} CIR₁^{power} (s)×CIRᵢ^{power} (s+t−1)+Σ_{s=N+2-t}^{N}CIR₁^{power}(S)×CIRᵢ^{power} (s+t−1−N), t=1, . . . , N
Detect the first peak in Corrᵢ(1:N), say j, which satisfies Corrᵢ(j)≥Corrᵢ(k) for any k>j and Corrᵢ(j) >Corrᵢ(m) for any m<j.
Cyclically shift CIRᵢ^{power} to make j the first tap, meaning CIRᵢ^{powerAlign}=[CIRᵢ^{power} (j:N) CIRᵢ^{power} (1:j−1)].
Repeat for CIR₂^{power} to CIR_{P}^{power} to get CIR₂^{powerAlign} to CIR_{P}^{powerAlign}, CIR₁^{powerAlign}=CIR₁^{power}.

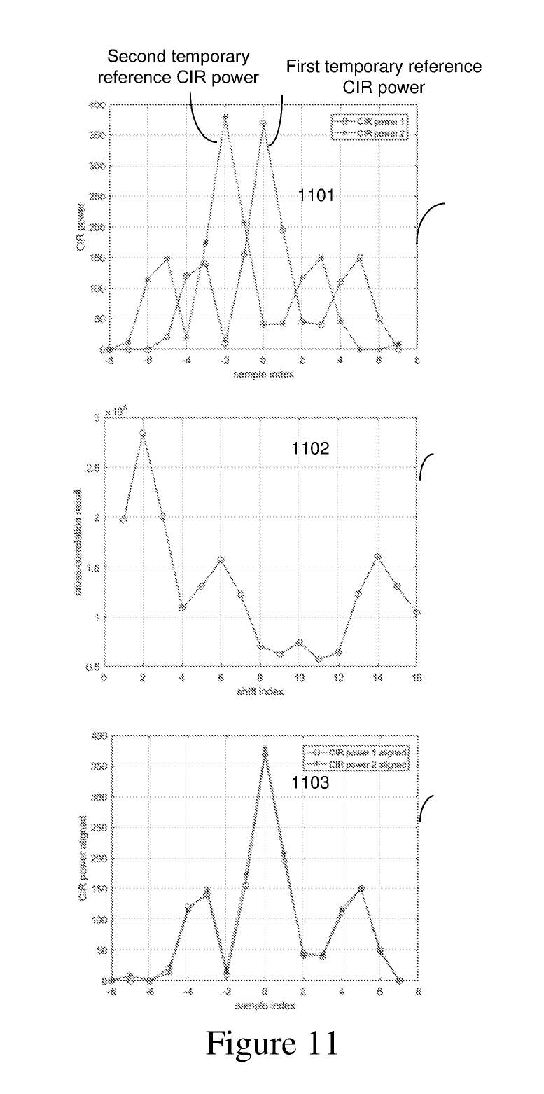

The Algorithm 2 for aligning the temporary reference CIR power may also be explained graphically by making references to the plots shown in FIG. 11.
Receiving a first packet, determining a first temporary reference CIR power, and using it as reference, which is the first temporary reference CIR power as shown in plot 1101.
Receiving a second packet and determining a second temporary reference CIR power, which is the second temporary reference CIR power as shown in plot 1101. The second temporary reference CIR power normally does not align with the first temporary reference CIR power, as shown in plot 1101.
Computing the cross-correlation between the first temporary reference CIR power and the second temporary reference CIR power, as shown in plot 1102.
Determining the peak in the correlation result, which is at tap position 2 in plot 1102.
Cyclically shifting the second temporary reference CIR power by 2 tap samples to the right, which would make the second temporary reference CIR power to align with the first temporary reference CIR power, as shown in plot 1103.

After aligning the temporary reference CIR power by using Algorithm 1, Algorithm 2 or any suitable algorithm, compute the average of CIR₁^{powerAlign}(1:N) to CIR_{P}^{powerAlign} (1:N) to get the reference CIR power CIR_{ref}^{power} (1:N), which satisfies:

$${CIR}_{ref}^{power} ( i ) = \frac{1}{P} {\sum }_{k = 1}^{P} {CIR}_{k}^{powerAlign} ( i )$$

The reference CIR power may be stored and used later for motion detection. Besides motion detection, the reference CIR power may also be used to detect the change of the surrounding environment. For example, the reference CIR power may be used to detect the presence of a new object, even if the new object is not moving, if the reference CIR power was collected when the new object was not in the scene.

In accordance with various aspects of the disclosure, detecting whether a motion of an object is occurring in the room may depend on a correlation degree between a received signal captured CIR power (i.e. a measured CIR power of the received signal) and the reference CIR power. The correlation degree may be represented by a real number ranging from 0 to 1 (i.e. 0% to 100%). A correlation degree of 0 (0%) may be interpreted to represent the received signal captured CIR power being independent of the reference CIR power (i.e. no correlation). A correlation degree of 1 (100%) may be interpreted to represent the received signal captured CIR power being identical to the reference CIR power. Since the reference CIR power is obtained when there is no expectation of movement or motion in the room, a received signal captured CIR power should be very similar to the reference CIR power when no motion is present in the room. In such a case, the computed correlation degree may be at the high end of the correlation degree range, like 90% to 100%. In case there is a motion in the room, or there is a change in the room environment, for example, due to the presence of a human or an object, the correlation degree between the received signal captured CIR power and the reference CIR power is at a low end of the correlation range. The value determined for the correlation degree may be compared to a correlation degree threshold for determining whether a motion of an object has taken place in the room. In one example, if the correlation degree is above the correlation degree threshold (i.e. more correlation to the reference CIR power), then it may be determined that no motion has taken place in the environment. Conversely, if the correlation degree is below the correlation degree threshold (i.e. less correlation to the reference CIR power), then it may be determined that at least some motion has taken place in the environment. The correlation degree threshold may be preprogrammed, or determined by the device during operation and other times.

The correlation degree threshold may be determined at any time and on demand by the processor in the device. The following algorithm may be used to determine the optimal correlation degree threshold.
From the measurements collected to determine the reference CIR power, the temporary reference CIR power CIR₁^{powerAlign} to CIR_{P}^{powerAlign} are known. The reference CIR power CIR_{ref}^{power} is also known. The algorithm for determining the optimal correlation degree threshold may involve computing the cross-correlation between each CIRᵢ^{powerAlign} and CIR_{ref}^{power}, i=1, 2, . . . P, and produce P number of correlation degrees CD₁ to CD_{P}. The following equation is used to compute the correlation of CIRᵢ^{powerAlign} and CIR_{ref}^{power}:

$${CD}_{i} = \frac{{\sum }_{k = 1}^{N} {CIR}_{i}^{powerAlign} ( k ) \times {CIR}_{ref}^{power} ( k )}{\sqrt{{\sum }_{k = 1}^{N} {{CIR}_{i}^{powerAlign} ( k )}^{2}} \times \sqrt{{\sum }_{k = 1}^{N} {{CIR}_{ref}^{power} ( k )}^{2}}}$$

Next, the algorithm involves using CD₁ to CD_{P} to obtain the correlation degree threshold CDₜₕ. The optimum correlation degree threshold CDₜₕ may be the minimum of CD₁ to CD_{P}. Alternatively, the optimum correlation degree threshold CDₜₕ may be the 2^{nd} minimum of CD₁ to CD_{P}. In another alternative, the optimum correlation degree threshold CDₜₕ may be the mean value of CD₁ to CD_{P}. In another alternative, the optimum correlation degree threshold CDₜₕ may be the median of CD₁ to CD_{P}. The optimum correlation degree threshold CDₜₕ may be based on any selection function involving one or more of the CD₁ to CD_{P}, and the selection function may be predetermined by experimentation and/or determined while the device is in operation in the room, as long as the selection function produces a reliable motion detection process.
The selected CDₜₕ may also be adjusted by CD_{adjust} to get the final correlation degree threshold CD_{Th}^{final}=CDₜₕ−CD_{adjust}. CD_{adjust} is a factor used to improve reliability of the motion detection process.

Since the reference CIR power is obtained when there is no expectation of movement or motion in the room, the correlation degree between each temporary reference CIR power and the reference CIR power should be very high, which will result in a high CDₜₕ. If we see that CDₜₕ is very low, for example, CDₜₕ<CD_{low}, it indicates that the reference CIR power is not reliable, either because there is motion when collecting the reference CIR power, or due to certain multipath pattern. To address such an issue, either collecting the reference CIR power again at another time to make sure no motion presents, or the user may change the location of one of the devices (e.g. D1 or D2) slightly to change the multipath pattern as possible ways to improve the accuracy of selected CDₜₕ.

The correlation degree threshold may be determined at any time and on demand by the processor in the device. Furthermore, a correlation degree threshold may be preprogrammed in the device based on laboratory experimentation and analysis. In such a case, the preprogrammed correlation degree threshold may be used as an initial value in a process for optimizing the correlation degree threshold that is then used in the process for motion detection. The following algorithm may be used to determine the optimal correlation degree threshold that could be used in the process of motion detection. If a correlation degree threshold is preprogrammed by the software in the device, the software can determine the optimal correlation degree threshold based on the measured received signal strength indicator (RSSI) and multipath amount. RSSI may be reported for every packet. A high level of RSSI indicates that the transmitter and the receiver are in a close proximity to each other. The CIR correlation degree between the reference CIR power and the received signal captured CIR power usually is higher with strong RSSI than with low RSSI. As such, when RSSI is relatively high, a correlation degree threshold at a high level may be selected for the process of motion detection. If RSSI is low indicating the transmitter and receiver being farther apart, then a correlation degree threshold at a low level may be selected in the process of the motion detection. The device may be preprogrammed with a particular mapping between the RSSI levels and various levels of the correlation degree threshold. For example, if RSSI>RSSI^{high}, a correlation degree threshold=Th_{high} may be used. If RSSI<RSSIₜₕ^{low}, a correlation degree threshold=Th_{low} may be used. Otherwise, a default midlevel correlation degree threshold=Th_{mid} may be selected.

The multipath amount of the received signal may also be used in the selection of the correlation degree threshold. A high level of multipath amount may be used as an indication that the signal propagation environment is a multipath rich environment. In a multipath rich propagation environment, CIR correlation degree between the reference CIR and the received signal captured CIR is generally at a low level. If the propagation environment as indicated by the multipath amount is a multipath rich environment, then a correlation degree threshold at a low level may be selected. If multipath amount is at a low level, CIR correlation degree between the reference CIR power and the received signal captured CIR power is generally at a high level. As such, if the multipath amount is at a low level, then a correlation degree threshold at a high level may be selected. The device may be preprogrammed with a particular mapping between the multipath amount levels and various levels of the correlation degree threshold, and the selection of the correlation degree threshold may be made in accordance with such a mapping. For example, if multipath amount >MAₜₕ^{high}, the selection for the correlation degree threshold may equal Th_{low}′. If multipath amount <MAₜₕ^{low}, the selection for the correlation degree threshold may equal Th_{high}′. Otherwise, a default midlevel correlation degree threshold equal to Th_{mid}′ may be selected.

In the cases of selecting the correlation degree threshold, the mapping of the RSSI and multipath amount to various correlation degree thresholds as described may include any mapping between a suitable number of RSSI levels, multipath amount levels and correlation degree threshold levels, although only low/mid/high levels are included in the disclosure.

In accordance with various aspects of the disclosure, detecting whether a motion of an object is occurring in the room may depend on a correlation degree between a first received signal captured CIR power and a second received signal captured CIR power. In this case, a reference CIR power is not needed in the algorithm. The correlation degree may be represented by a real number ranging from 0 to 1 (i.e. 0% to 100%). A correlation degree of 0 (0%) may be interpreted to represent the first received signal captured CIR power being independent of the second received signal captured CIR power (i.e. no correlation). A correlation degree of 1 (100%) may be interpreted to represent the first received signal captured CIR power being identical to the second received signal captured CIR power. If there is no motion present in the room, the first received signal captured CIR power should be very similar to the second received signal captured CIR power. In such a case, the computed correlation degree may be at the high end of the correlation degree range, like 90% to 100%. In case there is a motion in the room, the correlation degree between the first received signal captured CIR power and the second received signal captured CIR power is at a low end of the correlation range. The value determined for the correlation degree may be compared to a correlation degree threshold for determining whether a motion of an object has taken place in the room. In one example, if the correlation degree is above the correlation degree threshold (i.e. more correlation to the second received signal captured CIR power), then it may be determined that no motion has taken place in the environment. Conversely, if the correlation degree is below the correlation degree threshold (i.e. less correlation to the second received signal captured CIR power), then it may be determined that at least some motion has taken place in the environment. The correlation degree threshold may be preprogrammed, or determined by the device during operation and other times.

The motion detection may be based on the processes as described individually with respect to using the CIR correlation algorithm and the multipath amount algorithm. However, in accordance with the disclosure, the CIR correlation algorithm and the multipath amount algorithm can be combined in a selection process involving assigning a weighting factor to further improve the reliability of motion detection in a device. The device may perform both processes (i.e. involving CIR correlation algorithm and the multipath amount algorithm) and determine an outcome with respect to the motion detection. The combined process involves assigning a weighting factor to the outcomes of the motion detection based on the CIR correlation algorithm and the multipath amount algorithm. As a result, two outcomes from the motion detection processes may become available. In a combined motion detection process, a weighting factor may be applied to each algorithm outcome and then combined to produce a final outcome with respect to the motion detection process. The weighting factor may be W (between 0 to 1) and the selected value may be based on the measured RSSI and multipath amount.

Generally, a high RSSI level of the received signal is an indication that the transmitter and the receiver are in a close proximity to each other, which usually makes using the CIR correlation algorithm a more reliable process than using the multipath amount algorithm. As such, a high weighting W_{high} (a value closer to 1) may be used to factor the motion detection result using the CIR correlation algorithm, and a lower weighting W_{low} (a value closer to 0) may be to factor the motion detection result using the multipath amount algorithm. The combined motion detection result may be represented as: MD_{final}=W_{high}×MD_{CIR}+M_{low}×MD_{MA}. If MD_{final}>Th_{final}, then motion is detected.

Generally, a low RSSI indicates that the transmitter and the receiver are far away from each other, which usually makes the CIR correlation algorithm less reliable than the multipath amount algorithm. In such a case, a low weighting W_{low} (closer to 0) may be used to factor the motion detection result using the CIR correlation algorithm, and a high weighting W_{high} (closer to 1) may be used to factor the motion detection result using the multipath amount algorithm. The combined motion detection result may be represented as: MD_{final}=W_{low}×MD_{CIR}+W_{high}×MD_{MA}. If MD_{final}>Th_{final}, then motion is detected.

Generally, a high level of multipath amount indicates that the environment is multipath rich, which usually makes the outcome of the motion detection process using the CIR correlation algorithm more reliable than using the multipath amount algorithm. As such, a higher weighting W_{high} (i.e. closer to 1) may be used to factor the outcome of the motion detection process using the CIR correlation algorithm, and using a lower weighting W_{low} (closer to 0) may be used to factor the outcome of the motion detection process using the multipath amount algorithm. The combined motion detection result may be represented as: MD_{final}=MD_{high}×MD_{CIR}+W_{low}×MD_{MA}. If MD_{final}>Th_{final}, then motion is detected.

Generally, a low multipath amount indicates that the environment is mainly clear of objects/walls/etc. (i.e. multipath clean). In such a case, the outcome of the motion detection process using the CIR correlation algorithm less reliable than using the multipath amount algorithm. As such, a lower weighting W_{low} (closer to 0) may be used to factor the outcome of motion detection using the CIR correlation algorithm, and using a higher weighting W_{high} (closer to 1) may be used to factor the outcome of motion detection process using the multipath amount algorithm. The combined motion detection result may be represented as: MD_{final}=W_{low}×MD_{CIR}+W_{high}×MD_{MA}. If MD_{final}>Th_{final}, then motion is detected.

In accordance with the disclosure, any value for the RSSI higher than a threshold (i.e. RSSI>RSSIₜₕ^{high}) may be considered high RSSI, and any value for RSSI less than a threshold (i.e. RSSI<RSSIₜₕ^{low}), the RSSI may be considered a low level RSSI. A mapping between several levels of RSSI and the possible weighting factors may be used. Similarly, any value for the multipath amount higher than a threshold (i.e. multipath amount >MAₜₕ^{high}) may be considered a high multipath amount, and any multipath amount less than a threshold (i.e. multipath amount <MAₜₕ^{low}) may be considered a low multipath amount. A mapping between several levels of multipath amount and the possible weighting factors may be used.

Below table is an example of the mapping between different levels of RSSI/multipath amount and the corresponding weighting factors.

| | | | Weighting |
|---|---|---|---|
| | | Weighting | factor |
| | | factor | of |
| | | of CIR | multipath |
| RSSI | Multipath amount | correlation | amount |
| >−66 dBm | >200 ns | 0.9 | 0.1 |
| >−66 dBm | Between 50 ns and 200 ns | 0.7 | 0.3 |
| >−66 dBm | <50 ns | 0.5 | 0.5 |
| Between −86 dBm | >200 ns | 0.7 | 0.3 |
| and −66 dBm | | | |
| Between −86 dBm | Between 50 ns and 200 ns | 0.5 | 0.5 |
| and −66 dBm | | | |
| Between −86 dBm | <50 ns | 0.3 | 0.7 |
| and −66 dBm | | | |
| <−86 dBm | >200 ns | 0.5 | 0.5 |
| <−86 dBm | Between 50 ns and 200 ns | 0.3 | 0.7 |
| <−86 dBm | <50 ns | 0.1 | 0.9 |

The process of motion detection may involve coarse motion detection and fine motion detection processes. For coarse motion detection processes, data collection for motion detection may occur periodically with a long period of time passing between the data collection times (i.e. data collected every T1 seconds). For each data collection time, a number of data packets (i.e. N1 packets) may be transmitted and received. If the motion detection process outcome does not indicate detection of motion, the processes for motion detection may continue at the same or similar periodicity. If the motion detection process outcome indicates detection of motion, the processes for motion detection may continue with a fine motion detection processes. The fine motion detection may occur periodically with a shorter period of time passing between the data collection times (i.e. data collected every T2 seconds, where T2<T1). For each data collection time in the fine motion detection process, a number of data packets (i.e. N2 packets) may be transmitted and received, and the process may be repeated a number of time (i.e. K times). If motion is detected more than a threshold (i.e. Q times) out of K times, the outcome of the motion detection process may be considered as motion is being detected. If fewer than the threshold (i.e. Q times) the motion has been detected, the process would revert back to the coarse motion detection processes.

The coarse and fine motion detection processes may be summarized as following:

### <Coarse Motion Detection>

Step#1. Run N1 packets each time and get N1 CIR. Compute the power of the CIR and get N1 CIR power. Align the N1 CIR power to get N1 aligned CIR power.
Step#2. Compute the correlation between the reference CIR power CIR_{ref}^{power} and each aligned CIR power to get N1 correlation degree.
Step#3. Get the minimum of the N1 correlation degree.
Step#4. If the minimum is less than the correlation degree threshold CDₜₕ^{final}, coarse motion is detected and start fine motion detection. Otherwise, repeat step #1 to #3.

### <Fine Motion Detection>

Step#1. Run N2 packets each time and get N2 CIR. Compute the power of the CIR and get N2 CIR power. Align the N2 CIR power to get N2 aligned CIR power.
Step#2. Compute the correlation between the reference CIR power CIR_{ref}^{power} and each aligned CIR power to get N2 correlation degree.
Step#3. Get the minimum of the N2 correlation degree.
Step#4. Repeat step #1 to #3 for K times and get K min.
Step#5. If out of the K min, Q or more are less than the correlation degree threshold CDₜₕ^{final}, motion is detected. Otherwise, go to coarse motion detection.

At any time, if a packet shows a correlation degree <Th_{exception}, motion is detected. Th_{exception} is chosen to be very low to make sure that whenever this happens, the packet is very different from the reference which is caused by motion.

Using the reference CIR power is not necessary under certain condition. The correlation may also be computed between a first aligned CIR power and a second aligned CIR power to get a first correlation degree, and between the second aligned CIR power and a third aligned CIR power to get a second correlation degree. With multiple correlation degree determined, the same coarse motion detection, fine motion detection and exception processes can be used to detect motion.

Up-sampling may be applied to a CIR before computing correlation. Any existing up-sampling algorithm can be used to up-sample the CIR to a finer resolution. Using up-sampled CIR to compute correlation degree can improve motion detection performance.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those of ordinary skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for motion detection comprising:
determining a plurality of channel impulse response (CIR) power profiles over a plurality of time sampling taps of one or more received signals;
time aligning the plurality of the CIR power profiles based on time sampling taps of one or more occurrences of peak CIR power levels being above a threshold in each of the plurality of the CIR power profiles for generating a reference CIR power profile;
detecting motion based on a comparison of the reference CIR power profile to a captured signal CIR power profile.

2. The method as recited in claim 1 wherein the time aligning the plurality of the CIR power profiles is based on a time sampling tap of the first peak CIR power level being above the threshold in each of the plurality of the CIR power profiles.

3. The method as recited in claim 1 wherein the threshold used to time align the plurality of the CIR power profiles is based on a level of a time sampling tap of the strongest peak in each of the plurality of the CIR power profiles.

4. The method as recited in claim 1 wherein the time aligning the plurality of the CIR power profiles is based on presence of the strongest cross correlation level among two or more of the plurality of the CIR power profiles.

5. The method as recited in claim 1 wherein the comparison of the reference CIR power profile to the captured signal CIR power profile includes determining a correlation level between the reference CIR power profile and the captured signal CIR power profile, wherein when the correlation level is less than a correlation degree threshold presence of motion is declared.

6. The method as recited in claim 5 wherein the correlation degree threshold is based on a cross correlation level among two or more of the plurality of the CIR power profiles.

7. The method as recited in claim 5 wherein the correlation degree threshold is based on a cross correlation level between the reference CIR power profile and one or more of the plurality of the CIR power profiles.

8. The method as recited in claim 5 wherein the correlation degree threshold is based on a received signal strength of the one or more received signals.

9. The method as recited in claim 5 wherein the correlation degree threshold is based on a multipath amount of the one or more received signals.

10. The method as recited in claim 1 wherein the detecting motion based on a comparison of the reference CIR power profile to the captured signal CIR power profile is based on a coarse motion detection process, and followed by a fine motion detection process if the correlation degree threshold is below a level in the coarse motion detection process.

11. An apparatus for motion detection comprising:
a transceiver coupled to a processor and memory for storing instruction to perform:
determining a plurality of channel impulse response (CIR) power profiles over a plurality of time sampling taps of one or more received signals;
time aligning the plurality of the CIR power profiles based on time sampling taps of one or more occurrences of peak CIR power levels being above a threshold in each of the plurality of the CIR power profiles for generating a reference CIR power profile;
detecting motion based on a comparison of the reference CIR power profile to a captured signal CIR power profile.

12. The apparatus as recited in claim 11 wherein the time aligning the plurality of the CIR power profiles is based on a time sampling tap of the first peak CIR power level being above the threshold in each of the plurality of the CIR power profiles.

13. The apparatus as recited in claim 11 wherein the threshold used to time align the plurality of the CIR power profiles is based on a level of a time sampling tap of the strongest peak in each of the plurality of the CIR power profiles.

14. The apparatus as recited in claim 11 wherein the time aligning the plurality of the CIR power profiles is based on presence of the strongest cross correlation level among two or more of the plurality of the CIR power profiles.

15. The apparatus as recited in claim 11 wherein the comparison of the reference CIR power profile to the captured signal CIR power profile includes determining a correlation level between the reference CIR power profile and the captured signal CIR power profile, wherein when the correlation level is less than a correlation degree threshold presence of motion is declared.

16. The apparatus as recited in claim 15 wherein the correlation degree threshold is based on a cross correlation level among two or more of the plurality of the CIR power profiles.

17. The apparatus as recited in claim 15 wherein the correlation degree threshold is based on a cross correlation level between the reference CIR power profile and one or more of the plurality of the CIR power profiles.

18. The apparatus as recited in claim 15 wherein the correlation degree threshold is based on a received signal strength of the one or more received signals.

19. The apparatus as recited in claim 15 wherein the correlation degree threshold is based on a multipath amount of the one or more received signals.

20. The apparatus as recited in claim 11 wherein the detecting motion based on a comparison of the reference CIR power profile to the captured signal CIR power profile is based on a coarse motion detection process, and followed by a fine motion detection process if the correlation degree threshold is below a level in the coarse motion detection process.
